(19) United States
(12) Patent Application Publication
(10) Pub. No.: US 2023/0003194 A1
(43) Pub. Date: Jan. 5, 2023

(54) DEFORMABLE MODEL FOR PERFORMANCE ENHANCEMENT OF PHOTOVOLTAIC-WIND HYBRID SYSTEM

(71) Applicant: Abu Dhabi University, Abu Dhabi (AE)

(72) Inventors: Anas I.Q. Al Tarabsheh, Abu Dhabi (AE); Mohammad A. Ghazal, Abu Dhabi (AE)

(73) Assignee: Abu Dhabi University, Abu Dhabi (AE)

(21) Appl. No.: 17/367,371

(22) Filed: Jul. 4, 2021

(51) Int. Cl. F03D 9/00; F03D 7/06; F03D 3/00; H02S 10/12; H02S 20/30

(52) U.S. Cl. CPC F03D 9/007; F03D 7/06; F03D 3/005; H02S 10/12; H02S 20/30; F05B 2220/708; F05B 2240/214

(57) ABSTRACT

An apparatus includes a rotating pole, a first set of photovoltaic modules; and a second set of photovoltaic modules. At least one of the first set of photovoltaic modules is perpendicular to at least one of the second set of photovoltaic modules.

### BACKGROUND

Wind turbines convert wind (kinetic) energy into electrical energy via a gear box and a generator, or mechanical power. The electricity may then be distributed for use in an end user's electric system. In addition to wind turbines, photovoltaic modules or panels convert sunlight into electricity. However, such systems may be affected by weather conditions, such as when there is no wind or sunlight. In addition, elevated temperatures and dust accumulation may impact the electrical performance of such systems. Thus, cooling systems may be used to regulate photovoltaic system temperatures. However, no system currently exists that includes a hybrid solar and wind system that uses less features to maintain the hybrid system's overall temperature. Furthermore, no hybrid solar and wind system currently exists that increases the electricity production capacity of the hybrid solar and wind system.

### BRIEF DESCRIPTION OF DRAWINGS

FIG. 1A is an example diagram of a photovoltaic-wind hybrid turbine system;

FIG. 1B is an example top perspective view of a photovoltaic-wind hybrid turbine system;

FIG. 2A is an example graphical representation of maximum and minimum values of ambient temperatures by month;

FIG. 2B is an example graphical representation of maximum average and minimum values of wind speed;

FIG. 3A is an example slip ring;

FIG. 3B is an example electrical brushing;

FIG. 4A is an example hybrid charge controller (HCC);

FIG. 4B is an example load or warning light system;

FIG. 5 is an example graphical representation of measured photovoltaic modules or panels' surface temperature;

FIG. 6 is an example graphical representation of temperatures prior to and after blade rotations;

FIG. 7A is an example graphical representation of ideality factor and reverse saturation current;

FIG. 7B is an example graphical representation of measured and modeled data;

FIG. 8 shows an example controller;

FIG. 9 shows an example photovoltaic-wind hybrid system;

FIG. 10 shows an example graphical representation of average wind speeds;

FIG. 11 shows an example graphical representation of an example power curve of a wind turbine;

FIGS. 12A and 12B show example top and side perspective views of photovoltaic modules;

FIG. 13 shows an example data table;

FIG. 14 shows an example diagram of tilting and orientation of photovoltaic modules;

FIGS. 15A, 15B, and 15C show example diagrams of adjustments to turbine arms;

FIG. 16 is an example hybrid system;

FIGS. 17A and 17B are example hybrid systems;

FIG. 18 is an example network system; and

FIG. 19 is an example computing device.

### DETAILED DESCRIPTION OF PREFERRED EMBODIMENTS

The following detailed description refers to the accompanying drawings. The same reference numbers in different drawings may identify the same or similar elements.

Systems, devices, and/or methods describe herein a hybrid system that may use different energy resources, individually or at the same time. In embodiments, the hybrid system may use wind, solar, and/or a combination of wind and solar to generate energy. In embodiments, the hybrid system may include photovoltaic modules that are part of wind turbine blades. In embodiments, the wind turbines may be attached to a shaft that may rotate if wind is present. Thus, the hybrid system may use both wind and solar energy to generate energy. Accordingly, the hybrid system may (a) combine solar panels with wind turbine blades, (b) rotate photovoltaic modules can be self-cooled resulting in greater levels of energy output, (c) have no requirement for a sun tracker system, (d) increase the photovoltaic modules power output as wind turbine blades may reflect sunlight back onto the photovoltaic modules, and (e) reduce dust build-up on the system. In embodiments, the hybrid system may also include additional solar panels that are perpendicularly attached to the wind turbine blades that allow for additional energy output. In embodiments the wind turbine blades (with attached solar panels) may also be adjusted at a particular tilt angle to capture additional solar power.

As such, the hybrid system may use areas on wind blades to incorporate photovoltaic modules which will be self-cooled and result in greater energy output. In addition, the hybrid system described herein does not require a sun tracker and dust build-up in the system is reduced. In doing so, the hybrid system various advantages which include (i) less area utilized for the wind turbine blades and photovoltaic modules, (ii) photovoltaic modules that may move and generate additional power.

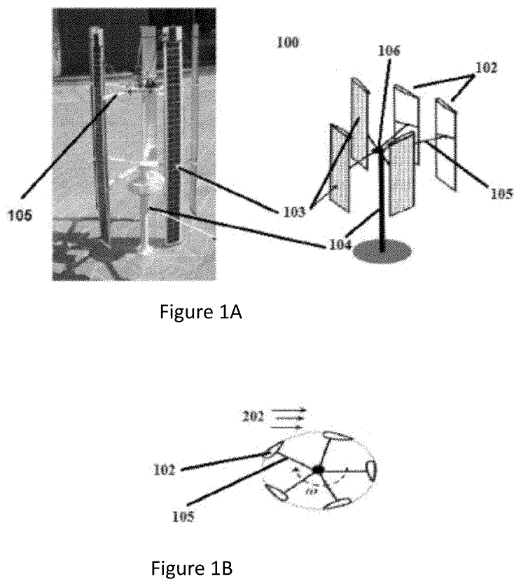

FIG. 1A is an example diagram of a photovoltaic-wind hybrid turbine system. As shown in FIG. 1A, hybrid system 100 includes photovoltaic (PV) modules 103. In embodiments, PV modules 103 may be constructed of a flexible material that allows for PV modules 103 to be attached to wind turbine blades 102 (hereinafter blades 102). In embodiments, PV modules 103 may also be defined as PV panels. In embodiments, hybrid system 100 may be a vertical-axis wind turbine (VAWT) design. In embodiments, with hybrid system 100 being a VAWT design, hybrid system 100 generates less noise than a horizontal-axis wind turbine (HAWT). In addition, with hybrid system 100 being a VAWT design, lower angular velocity occurs during operation and can accept wind from any direction towards hybrid system 100.

In embodiments, as shown in FIG. 1A, a plurality of PV modules 103 are attached to blades 102 of an H-type VAWT design, with five blades 102 that are separated between each other at an angle of 72 degrees. In embodiments, PV modules 103 may be constructed of a material that can be bent up to an angle of 30 degrees to allow for conformity to any curvatures of blades 102. In embodiments, dimensions of PV modules 103 may match that of blades 102 so that the aerodynamics of the wind turbine portion of hybrid system 100 are not affected (i.e., minimized).

FIG. 1B shows an example top perspective view of hybrid system 100. Wind speed V_{wind} 200 is shown in FIG. 1B. In embodiments, hybrid system 100, as shown in FIGS. 1A and 1B, will not see an increase in temperature due to absorbed solar radiation as blades 102 are rotating and any generated heat is exchanged with the surrounding environment at a rate faster than if PV modules 103 were stationary. In embodiments, hybrid system 100 is a self-cooling system with no extra power consumption needed for the self-cooling. As PV modules 103 cool down the system, the overall performance of hybrid system 100 is increased. In addition, attaching PV modules 103 to blades 102, there is a reduction of dust accumulation on hybrid system 100.

In embodiments, wind may cause blades 102 to rotate which then results in the rotation of shaft 104. In embodiments, blades 102 are connected to a central axis of shaft 103 through a plurality of radial arm structures 105. In embodiments, shaft 104 may be electrically connected to a generator (e.g., an alternator) which may be located at the bottom of shaft 104. In alternate embodiments, a three-phase alternating current (AC) permanent magnet generator may be located at the bottom of shaft 104. In embodiments, magnets (e.g., neodymium magnets) may be used instead of excitation coils that are used in synchronous generators. In embodiments, the generator converts any rotational energy of blades 102 into electricity. In embodiments, hybrid system 100 does not require a sun tracker since at least one rotating PV module 103 is facing the sun at any given time. In addition, a plurality of blades 102 may reflect sunlight back towards other PV modules 103. As such, hybrid system 100 can generate additional power.

Considering a preferred embodiment of the present invention, the photovoltaic modules or panels 103 are integrated with the H-type vertical-axis wind turbine (VA WT) consisting of five blades 102, each blade with a height (h) of 0.745 m and a width (w) of 0.08 m. A rotor 106 of the wind turbine has a diameter (d) of 0.56 m. The wind has a speed of V wind (in mis) which rotates the central axis of rotation or rotating shaft 104 with a speed N (in RPM) at a rotation frequency (in rad/s) of

$$ω ω = N \frac{2 π}{60}$$

and the resulting turbine speed (in m/s) will be

$${V}_{T} = ω \frac{d}{2}$$

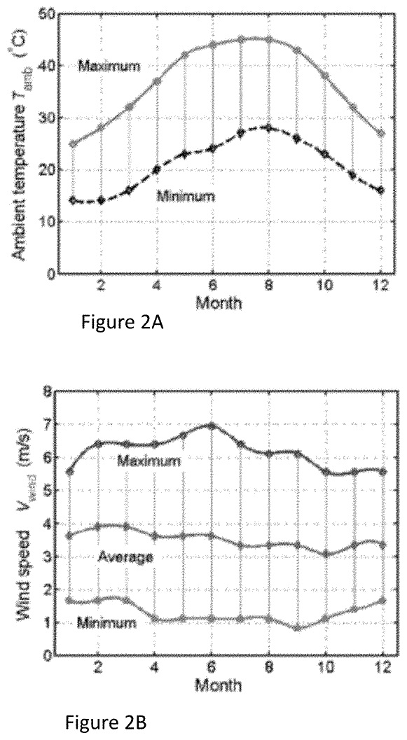

FIG. 2A shows an example graphical representation of maximum and minimum values of ambient temperatures by month. FIG. 2B is an example graphical representation of maximum average and minimum values of wind speed. In a non-limiting example, hybrid system 100 is tested based on the temperature and wind speed information provided in FIGS. 2A and 2B. In embodiments, FIG. 2A shows temperatures as they vary during each month with minimum and maximum temperatures shown. FIG. 2B shows maximum, average, and minimum wind speeds during each month. In this non-limiting example, FIGS. 2A and 2B are showing temperature and wind information in Abu Dhabi.

In embodiments, hybrid system 100, as being used in Abu Dhabi in this non-limiting example, includes PV modules 103 that absorb sunlight and generate power at the same time that blades 102 generate rotational power, when rotated by wind, which is then converted to electrical power via shaft 104. In embodiments, power generated from PV modules 103 and blades 102 is integrated together via a hybrid charge collector (HCC). In embodiments, direct current (DC) power is generated from PV modules 103 while AC power is generated from blades 102. In embodiments, HCC controls and mixes the generated DC and AC power and then stores the resultant power in a battery.

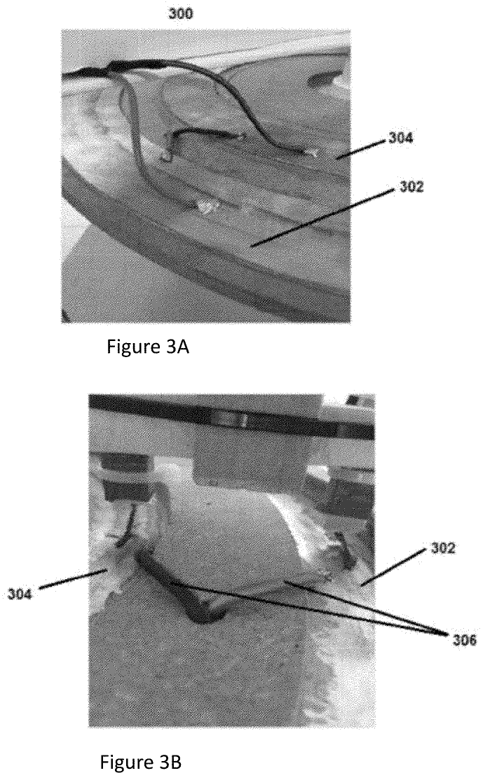

In embodiments, due to the rotation of blades 102 along with PV modules 103, electrical brushing may be used to collect electrical power generated from PV modules 103. In embodiments, electrical brushing is a process by which moving or rotating parts are electrically connected to stationary parts by brushing stationary wires on the moving parts. In embodiments, slip rings may be manufactured using two double-sided copper plates and a wooden board. FIGS. 3A and 3B show slip ring 300 with electrical brushes. As shown in FIG. 3A, outer ring 302 of slip ring 300 is used for positive terminals of PV modules 103 and inner ring 304 is used for negative terminals of PV modules 103. On another side of slip ring 300, two stationary wires 306 brush on the outer ring 302 and inner ring 304 which results in electrical current being passed to HCC and then to a battery.

In embodiments, an HCC may be connected to batteries (e.g., 12-volt batteries). In embodiments, output voltage and front side temperature values of PV modules 103 is analyzed and recorded using a microcontroller which is fixed to the top of rotor 106. In embodiments, a temperature T of PV modules 103 is determined by an ambient temperature (T_{amb}) and incoming solar radiations, ϕ, such that the higher the solar radiations, the larger the temperature T will be for ambient temperatures.

In embodiments, a Maximum Power Point Tracking (MPPT) is an algorithm that is included in charge controllers for extracting maximum available power from PV modules 103. In embodiments, the voltage at which a PV module 103 can produce maximum power is called maximum power pint (e.g., peak power voltage). In embodiments, for hybrid system 100, MPPT is used to increase the efficiency of PV modules 103. In embodiments, MPPT may be used a voltage regulator in a circuit that limits the amount of current being used to charge a battery and the amount of current being drawn from a battery in order to avoid damage to the battery. Thus, since PV modules 103 output more voltage than a battery can require for charging, hybrid charge controller (HCC) converts excess voltage, coming from PV modules 103, into current which results in optimized charging and the amount of time to charge the battery is reduced.

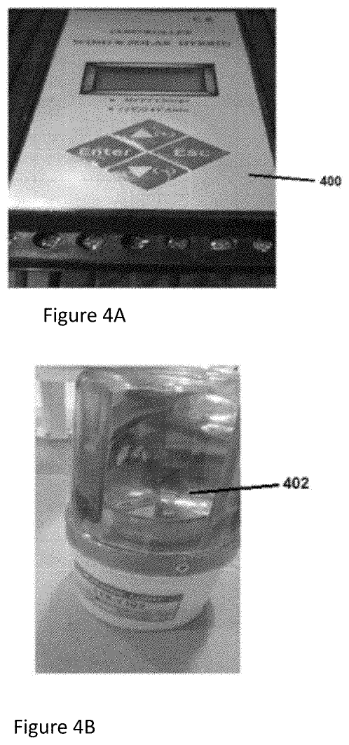

FIG. 4A shows an example HCC. In embodiments, when a battery being charged by hybrid system 100 gets full, hybrid system 100 may continue to charge the battery. In embodiments, HCC 400 may (1) turn on and divert energy to a load or a warning light 402 as shown in FIG. 4B. In embodiments, when the battery discharges, HCC 400 may turn off allowing hybrid system 100 to continue charging the battery. In embodiments, warning light 402 may be a 10-watt warning light that voltage from hybrid system 100 is being diverted.

In embodiments, the H-type vertical-axis wind turbine (VAWT) consisting of five blades 102 has a maximum power of 75 W, each blade with a height (h) of 0.745 m, a width (w) of 0.08 m and a rotor diameter (d) of 0.56 m. The swept turbine area A is given by A=h×d=0.417 m². Power absorbed by the turbine PT is expressed as:

$${P}_{T} = \frac{1}{2} \times Cp \times d \times h \times ρ \times {V}_{wind}^{3}$$

wherein Cp is the aerodynamic power coefficient, ρ=10225 kg/m3 is the air density, and V_{wind} is the wind speed.

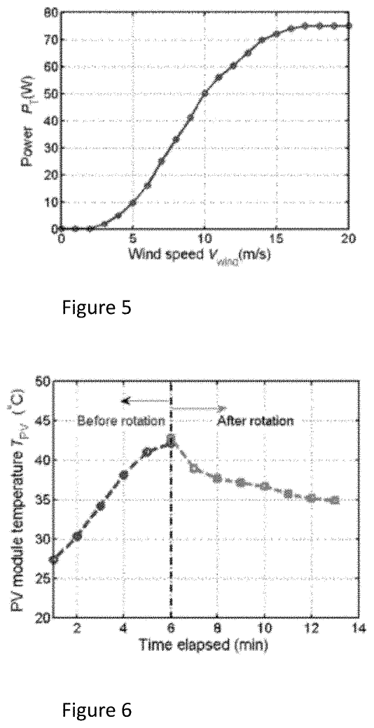

FIG. 5 shows example graphical representation of measured photovoltaic modules or panels' surface temperature. As shown in FIG. 5, a power characteristic curve is shown with wind speed versus power. In embodiments, FIG. 5 shows a curve where no power is produced when the wind speed is below a particular threshold, such as 2 m/s as shown. As shown in FIG. 5, the maximum power is generated at around 17 m/s. Also, as shown in FIG. 5, power increases at a much faster rate between 5 m/s and 10 m/s than the rate of power increases after 10 m/s. At higher wind speeds, control of the wind turbine feature is important than increased power at higher rates of wind.

FIG. 6 shows is an example graphical representation of temperatures prior to and after blade rotations. As shown in FIG. 6, the electrical characteristics of the photovoltaic modules or panels 103 are displayed in comparison before and after rotation of the H-type vertical-axis wind turbine (V AWT). A comparison of the measured photovoltaic modules or panels' surface temperature prior to rotation of the plurality of blades 102 (stationary state) and after rotation of the plurality of blades 102 of the H-type vertical axis wind turbine (VAWT) is compared in FIG. 6. This comparison helps to evidence the enhancement of effectiveness or performance of the photovoltaic modules or panels 103 when the plurality of blades 102 commence to rotate. As seen in FIG. 6, the temperature of PV modules 103 decreases (experimentally measured from 42° C. to 35° C. in a period of 7 minutes) when the H-type vertical-axis wind turbine (VAWT) starts rotating. Keeping PV modules 103 as fixed, as in a stationary position as in the traditional systems, results in an increased operating temperature of PV modules 103 (experimentally measured from 28° C. to 42° C. in a period of 6 minutes) due to the reason that PV modules 103 continuously absorb solar radiations.

In embodiments, current-voltage characteristics (I/V) of the photovoltaic modules or panels 103 are expressed as:

$$I = {I}_{o} \times ⌈ exp [ \frac{V - I \times {R}_{s}}{n \times {V}_{t h}} ] - 1 ⌉ + \frac{V - 1 \times {R}_{s}}{{R}_{p}} - {I}_{s c}$$

wherein V is the applied voltage to the module, I is the resulting current, Vₜₕ=25.9 mV (at room temperature) is the thermal voltage, n is the ideality factor, Ise is the short-circuit current, Rₛ is the series resistance, Rₚ is the shunt resistance and Iₒ is the reverse saturation current. This reverse saturation current I0 is expressed as equation (3):

$$I = {I}_{o - n o m} \times {[ \frac{{T}_{p v}}{300} ]}^{3} {e}^{[ \frac{Tpv}{300} - 1 ] \times \frac{{E}_{g}}{n \times {V}_{TH}}}$$

Where Iₒ₋ₙₒₘ is the reverse saturation current at T=300K. The most affected electrical parameter of the photovoltaic modules or panels 103 is the open-circuit voltage V_{∞} that decreases drastically when Tₚᵥ increases as a result of the absorption of sun radiation. This effect is reflected directly on the electrical efficiency of the PV modules 103.

Considering equations (2) and (3), open circuit voltage V_{∞} is approximated by assuming a reasonable large value of shunt resistance as equation (4):

$${V}_{o c} = n \times {V}_{t h} \times [ ln [ \frac{{I}_{s c}}{{I}_{o - n o m}} ] - 3 \times ln [ \frac{{T}_{P V}}{300} ] + [ [ \frac{{T}_{P V}}{300} - 1 ] \times \frac{{E}_{g}}{n \times {V}_{t h}} ] ]$$

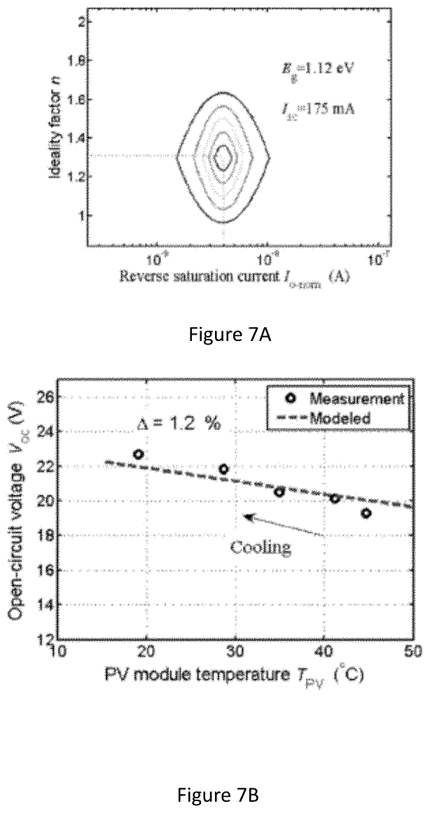

FIG. 7 is a graphical representation of measured and modelled open-circuit voltage plotted against measured photovoltaic modules or panels temperature. As shown in FIG. 7, modelling parameters are set (in MATLAB©) to n=1.3, Iₒ₋ₙₒₘ=4 nA, I_{sc}=175 mA and E_{g}=1.12 eV. This results in a difference of Δ=1.2% between measured and modelled data where Δ is defined in equation (5) as:

$$Δ = \frac{1}{N} \sqrt{{\sum }_{i = 1}^{N} \frac{{( m e a s u r e m e n {t}_{i} - {modeled}_{i} )}^{2}}{{( m e a s u r e m e n {t}_{i} )}^{2}} ,} N = 5 readings$$

FIG. 7 also shows that voltage decreases from 22.7 Y to 19.3 Y when temperature of PV modules 103 increases from 19° C. to 44° C. Therefore, cooling PV modules 103 by rotation of the same, increases the output voltage. FIG. 7(b) displays measured and modelled open-circuit voltage plotted against the measured photovoltaic modules or panels temperature. FIG. 7(a) shows optimum values of the ideality factor and reverse saturation current. In accordance with the graph, optimum values of the ideality factor and reverse saturation current are 1.3 and 4 nA, respectively, and FIG. 7(b) shows that the difference between the measured and the modelled data (Δ) is 1.2%.

Accordingly, the benefit of the proposed design over traditional turbine systems is that electrical performance of the rotating PV modules 103 is enhanced due to the self-cooling capability of the rotating PV modules 103 integrated with the plurality of blades 102. It has been experimentally shown that voltage of the PV modules 103 decreases when temperature of PV modules 103 temperature increases. Therefore, cooling of PV modules 103 by rotation increases the output voltage and thus overall performance of the proposed photovoltaic-wind hybrid turbine system 100. This experiment is modelled by four parameters—ideality factor, reverse saturation current, short-circuit current, and material band gap.

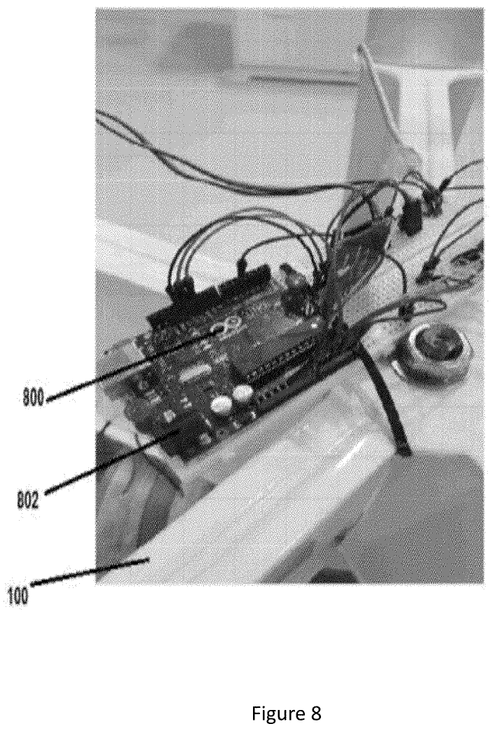

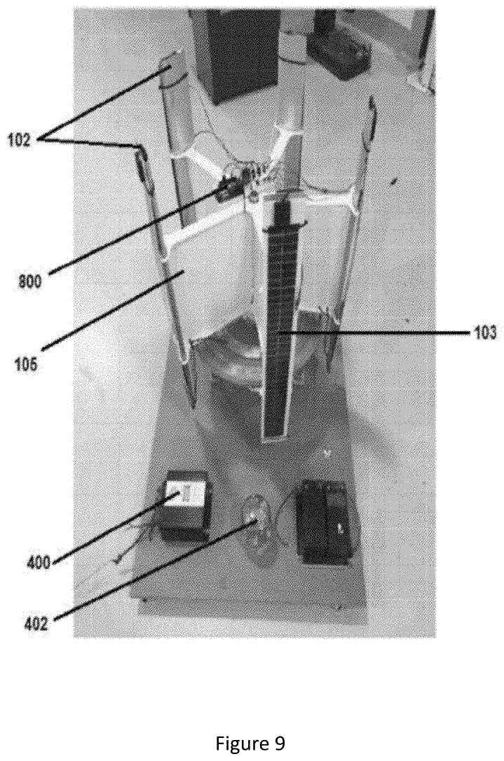

As shown in FIG. 8, a breadboard circuit containing the Arduino Uno microcontroller 800 and the SD card 802 are mounted on the photovoltaic-wind hybrid turbine system 100 using cable ties. In addition, FIG. 9 shows a representation of the overall photovoltaic-wind hybrid turbine system 100. Manufacturing steps used to build the overall system include attaching five photovoltaic modules or panels to the blades of the wind turbine using two cable ties for each panel, one on the top and one on the bottom. Further, five sturdy and light cardboard sheets of dimensions 23.5 cm×30 cm are cut and each cardboard sheet is fitted into an empty space bounded by two horizontal aluminum frames holding the blade, vertical blade and vertical shaft of the turbine. Slip rings are fabricated by cutting a wooden board in a circular shape with a diameter of 42 cm and making a hole in the middle of the wooden board enough for the shaft of the wind turbine to pass through. Following this, two circular-even crevices are created on the circular wooden board (both 3 cm wide and about a few mm deep), the circular crevices about 3 cm apart. Two sanded and cleaned smooth copper rings that fit exactly into the crevices are taken and the structure is glued to the bottom the wind turbine placing the slip ring underneath the generator. Any friction associated with the slip rings is eliminated or minimized by polishing surfaces of the slip rings. The lower the friction the higher the speed of the wind turbines and therefore higher electrical output power. A wooden base is then fabricated by cutting a wooden sheet of dimensions 80 cm×60 cm.

In embodiments, for hybrid system 100, the wind turbine, the hybrid charge controller (HCC) and the battery are bolted down to the wooden base and an on/off switch is placed on top of the wooden base. Holes being drilled are made big enough to allow any wiring coming from the photovoltaic-wind hybrid turbine system to go underneath and to the hybrid charge controller (HCC) and battery.

In embodiments, an LM35 temperature sensor is a precision IC (integrated circuit) used which senses temperature by giving an output voltage directly proportional to Centigrade temperature. The LM35 temperature sensor does not require any calibration in order to obtain an error range of +/−0.25° C. at room temperature and +/−0.75° C. at a range of −55° C. to 150° C. which is an advantage over Kelvin calibrated temperature sensors since no subtraction is required to be performed from the output voltage to obtain a value in centigrade.

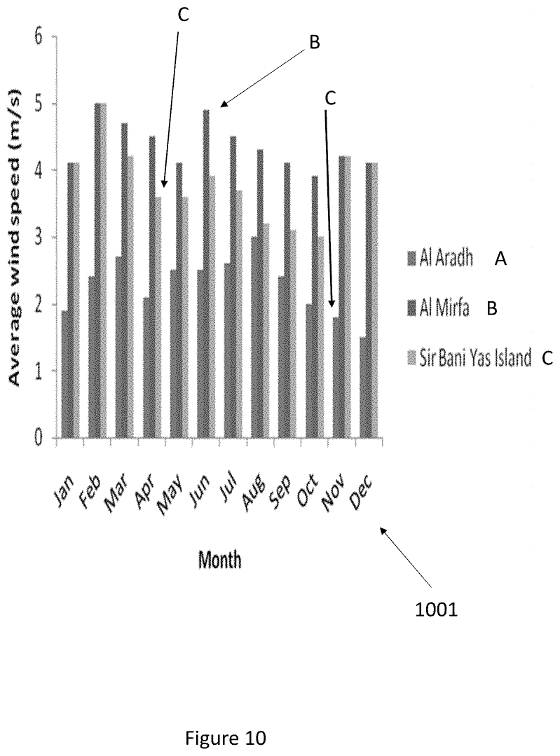

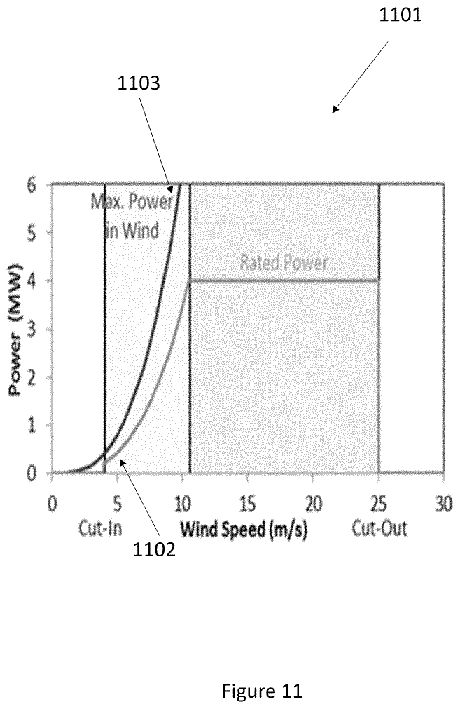

FIG. 10 shows an example graphical representation of table 1001 of average wind speeds in a particular geographic region. In embodiments, these average wind speeds may be used as electronic data to analyze the performance of one or more hybrid systems described in the one or more figures. FIG. 11 shows an example graphical representation (graph 1101) of example power curve of a wind turbine. As shown, this example power curve has a cut-in speed of 4.5 m/s. In embodiments, the cut-in speed is a speed at when a turbine starts to generate power. As shown in FIG. 11, no power is generated until the example wind turbine blade's reach a speed of 4.5 m/s (as shown with curve 1102). As shown in FIG. 11, curve 1102 continues to increase until it reaches the turbine's rated power. Also, as shown in FIG. 11, curve 1103 shows the maximum power in the wind which may be greater than the maximum rated power production of the wind turbine. In embodiments, curve 1102 provides power unless the wind speed is greater than 25 m/s (cut-out speed).

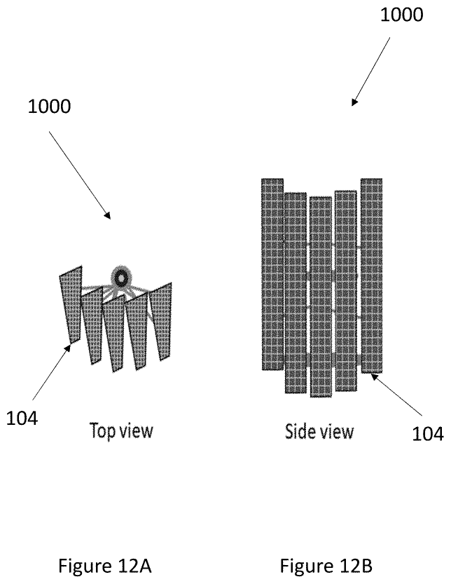

In embodiments, another hybrid system, with some features similar to hybrid system 100, can include additional photovoltaic modules which can maximize received solar radiation with additional tilting and orientating features. In a non-limiting example, another hybrid system, such as hybrid system 1000 (as shown in, for example, FIGS. 12A and 12B) may be adjusted in a particular direction. In this non-limiting example, the hybrid system is adjusted to a southerly direction when the wind speed is less than the cut-in speed of the hybrid system's turbine. Thus, in this non-limiting example, the hybrid system adjusts the positions (i.e., angles) of the wind turbine's arms to unfold the photovoltaic modules in the southern direction. In embodiments, hybrid system 1000 may be interacting with wind speeds as shown in FIG. 10. In this non-limiting example, hybrid system 1000 may have the example power curve described in FIG. 11. Accordingly, the photovoltaic modules described in FIGS. 12A and 12B may be tilted at a particular angle and particular direction.

As shown in FIG. 12A, a top perspective view of PV modules 104 is shown when PV modules 104 are at a particular angle. In embodiments, a side perspective view of the same PV modules 104, shown in FIG. 12A, are shown in FIG. 12B.

In embodiments, hybrid system 1000 may use active tracking to determine tilt angles. In embodiments, active tracking includes using solar sensors that used to determine the exact location of the sun and then tilt one or more PV modules 104 for maximum possible solar radiation. Thus, hybrid system can provide PV modules 104 which are part of wind turbine blades that can rotate and generate power from wind and also maximize power generated from solar radiation by tilting one or more PV modules 104.

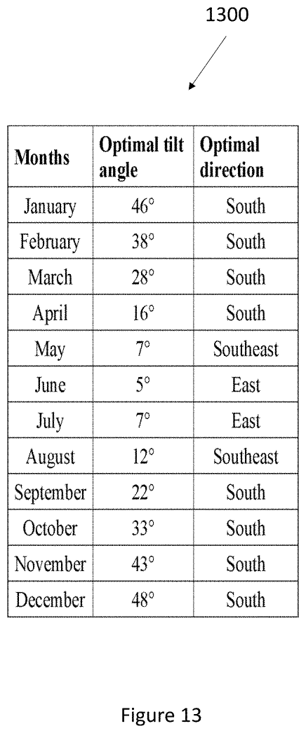

In a non-limiting example, as shown in FIG. 13, within example table 1300, the optimum tilt angle can be varied depending on the time (e.g., month) of the year in a particular location. In this non-limiting example, optimum tilt angles were analyzed for the United Arab Emirates (UAE) and are shown in FIG. 13. For example, in August, the optimal tilt angle is 12 degrees with an optimal direction of the southeast. In embodiments, table 1300 may be an electronic database that includes electronic data with locations, angles, and other directions. In embodiments, table 1300 may electronically provide information to a hybrid system, such as hybrid system 1000.

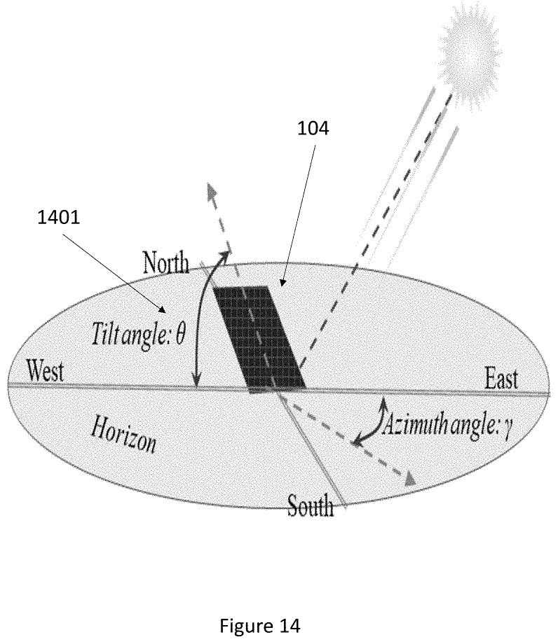

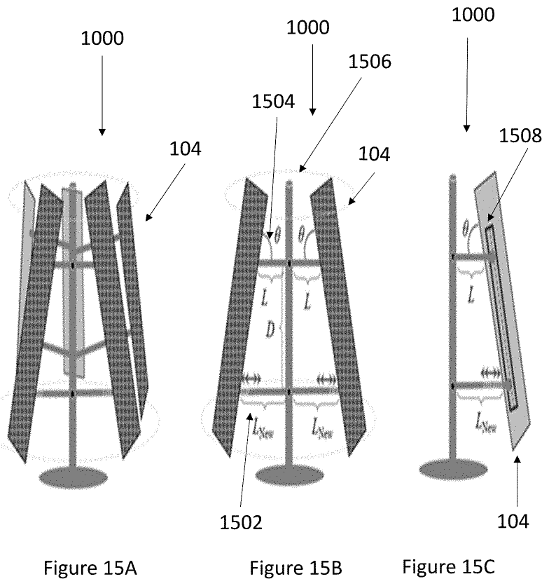

Accordingly, as shown in FIG. 14, the tilt angle (tilt angle 1401) of a photovoltaic module (e.g., PV module 104) is shown. Also, as shown in FIG. 14, the azimuth angle is shown in comparison to the easterly direction. To further show how optimal tilt angle can be used to enhance receiving solar radiation, FIGS. 15A, 15B, and 15C describe PV modules 104 at particular optimal tilt angles.

As shown in FIG. 15A, hybrid system 1000 may have multiple PV modules 104. In embodiments, hybrid system 1000 is further described in FIG. 15B showing arms 1502 and 1504. In embodiments, arms 1502 are adjustable and permit the change of angle so that the optimal tilt angle, θ, is always present. In embodiments, arms 1502 and 1504 are attached to pole 1506 that rotates from wind. In embodiments, arms 1504 are fixed. In alternate embodiments, arms 1504 can also be adjustable. As shown in FIG. 15C, the back perspective view of one PV module 104 is shown and includes a panel 1508 which can be used to connect arms 1502 and 1504 are connected to PV module 104.

In embodiments, the length of arm 1504, in relation to the tilt angle, may be:

$${L}_{NEW} = L + \frac{D}{tan θ}$$

Where the new length of arm 1504 is based on the original length of arm 1504, before the tilt, and the tilt angle and the diameter, D, of the overall hybrid system 1000. In embodiments, the tilt angle also has a relationship with the azimuth angle, γ. In embodiments, the embedded system controls the linear actuators to meet the wind turbine arms' required lengths. When the wind turbine is not rotating (e.g., such as when the wind speed is less than the turbine's cut-in speed), and PV modules 104 are not facing the sun, the embedded system can control the positions (angles) of the wind turbine's arms to unfold the PV modules in the sun's direction.

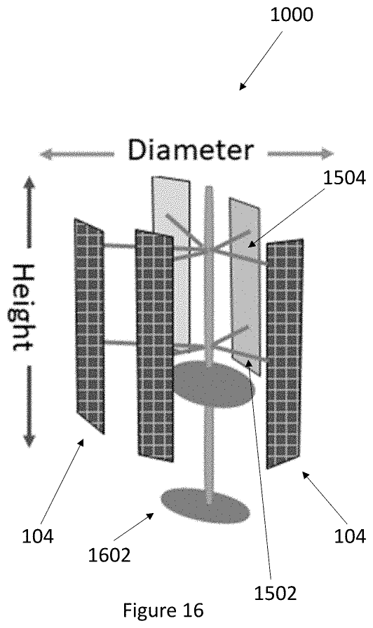

FIG. 16 shows another example perspective view of hybrid system 1000. As shown in FIG. 16, hybrid system 1000 may have a particular diameter and height. In embodiments, the diameter is determined by the lengths of arms 1502 and 1504 and the rotor diameter 1602. In embodiments, the swept area, i.e., effective area, is a cross-sectional area of the wind turbine. In embodiments, the swept area is the rotor height multiplied by the rotor diameter. Thus, hybrid system 1000 has a swept area along with the tilting features of PV modules 104.

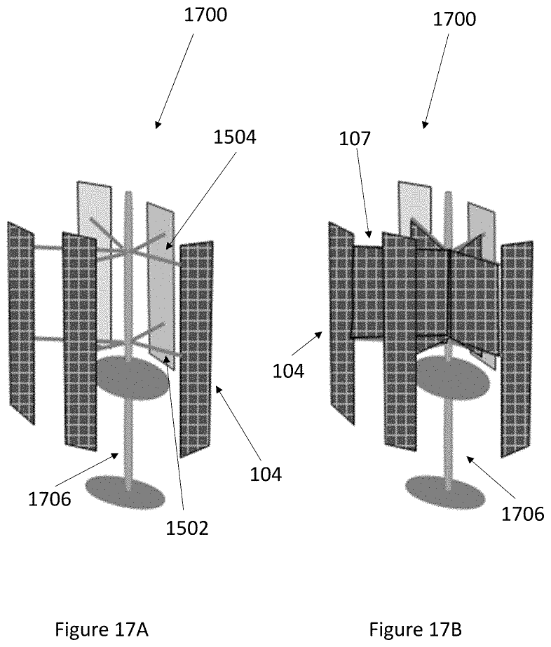

FIG. 17A shows an example perspective view of hybrid system 1700. As shown in FIG. 17A, hybrid system 1700 has arms 1702 and 1704. As shown in FIG. 17B, hybrid system 1700 may further include additional photovoltaic modules (PV modules 107) to increase the wind turbine's effective swept area and the effective area of the PV modules. Thus, this design increases the energy yield compared to that of the existing prototypes. In embodiments PV modules 107 are placed within spaces that are created by arms 1702 and 1704. In embodiments, arms 1702 and 1704 may have sleeves or slots within which PV modules 107 can fit. In alternate embodiments, PV modules 107 may be attached via screws or other types of connectors that prevent PV modules 107 from coming lose when hybrid system 1700 is turning. In alternate embodiments, there are no arms 1702 and 1704 that attach from pole 1706. Instead, PV modules 107 are directly attached to the rear surface (facing pole 1706) of PV modules 104 and the other edge of each PV module 107 is attached to pole 1706. In embodiments, with the additional combined surface area of PV modules 104 and 107, the amount of captured solar radiation power can be increased.

In embodiments, each PV module 104 may be tilted while each PV module 107 may remain fixed to pole 1706. In embodiments, screws or connectors between PV module 104 and 107 may be adjustable, via a computing device or controller as described in the figures, that allows for PV module 104 to tilt at a particular angle while still being fixed to PV module 107. In further embodiments, PV module 107 may be adjustable at a particular angle and may result in each of PV modules 104 coming closer together even to the point of one or more PV modules 104 touching each other. In embodiments, one or more of PV modules 107 may be controllable by a computing device, such as those described in one or more figures and PV modules 107 may be attached via hinges, screws, or other mechanism, that are connected to one or more controllers, that allows for PV module 107 to be adjustable.

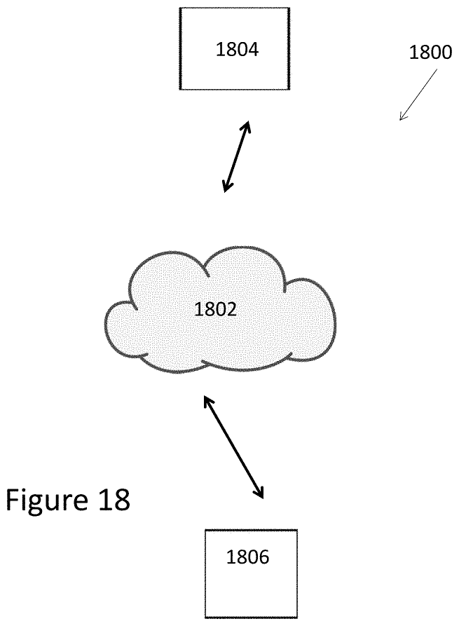

FIG. 18 is a diagram of example environment 1800 in which systems, devices, and/or methods described herein may be implemented. FIG. 18 shows network 1802, system 1804 and system 1806.

Network 1802 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light Fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or network 402 may include a cellular network, a public land mobile network (PLMN), a second-generation (2G) network, a third-generation (3G) network, a fourth-generation (4G) network, a fifth-generation (5G) network, and/or another network. In embodiments, network 402 may allow for devices describe any of the described figures to electronically communicate (e.g., using emails, electronic signals, URL links, web links, electronic bits, fiber optic signals, wireless signals, wired signals, etc.) with each other to send and receive various types of electronic communications.

System 1804 (e.g., hybrid system 100, hybrid system 1000, etc.) may include one or more devices that can communicate and/or receive electronic information to/from device 1806 via network 1802. In embodiments, system 1804 may include controllers, sensors, and/or any other electronic device that may receive information to optimally generate power. In embodiments, system 1806 may be a computing device that can store electronic information that can generate various graphical and table features as described in one or more figures. In embodiments, system 1804 may send electronic information to system 1806, and, system 1806 may send electronic information to one or more features in system 1804. In embodiments, system 1806 may be attached to, or co-located, with system 1804.

Device 1806 may include any computation or communications device that is capable of communicating with a network (e.g., network 1802) with other device and/or systems, such as system 1804. For example, device 1806 may include a computing device, radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smartphone, a desktop computer, a laptop computer, a tablet computer, a camera, a digital watch, a digital glass, or another type of computation or communications device.

Device 1806 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 1806. Device 1806 may have a touch screen and/or a keyboard that allows a user to electronically interact with an electronic application. In embodiments, a user may swipe, press, or touch device 1806 in such a manner that one or more electronic actions will be initiated by device 406 via an electronic application.

Device 1806 may include a variety of applications, such as, for example, a solar analyzer application, a wind flow analyzer application, a temperature application, a location analyzer, and/or other types of electronic applications that can be used to optimize a hybrid system described in one or more figures.

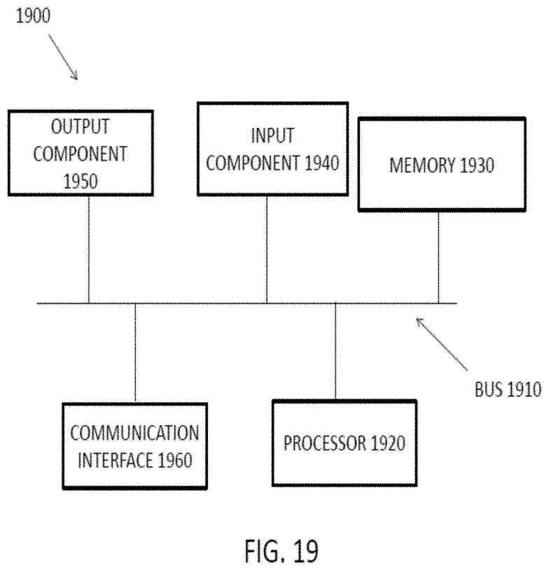

FIG. 19 is a diagram of example components of system hybrid system 100 and hybrid system 1000. Device 1900 may correspond to computing devices to a computing device feature that is part of systems 100, 1000, or 1806.

As shown in FIG. 19, device 1900 may include a bus 1910, a processor 1920, a memory 1930, an input component 1940, an output component 1950, and a communications interface 1960. In other implementations, device 1900 may contain fewer components, additional components, different components, or differently arranged components than depicted in FIG. 19. Additionally, or one or more components of device 1900 may perform one or more tasks described as being performed by one or more other components of device 1900.

Bus 1910 may include a path that permits communications among the components of device 1900. Processor 1920 may include one or more processors, microprocessors, or processing logic (e.g., a field-programmable gate array (FPGA) or an application-specific integrated circuit (ASIC)) that interprets and executes instructions. Memory 1930 may include any type of dynamic storage device that stores information and instructions, for execution by processor 1920, and/or any type of non-volatile storage device that stores information for use by processor 1920.

Input component 1940 may include a mechanism that permits a user to input information to device 1900, such as a keyboard, a keypad, a button, a switch, etc. Output component 1950 may include a mechanism that outputs information to the user, such as a display, a speaker, one or more light-emitting diodes (LEDs), etc.

Communications interface 1960 may include any transceiver-like mechanism that enables device 1900 to communicate with other devices and/or systems. For example, communications interface 1960 may include an Ethernet interface, an optical interface, a coaxial interface, a wireless interface, or the like.

In another implementation, communications interface 1960 may include, for example, a transmitter that may convert baseband signals from processor 1920 to radiofrequency (RF) signals and/or a receiver that may convert RF signals to baseband signals. Alternatively, communications interface 1960 may include a transceiver to perform functions of both a transmitter and a receiver of wireless communications (e.g., radiofrequency, infrared, visual optics, etc.), wired communications (e.g., conductive wire, twisted pair cable, coaxial cable, transmission line, fiber optic cable, waveguide, etc.), or a combination of wireless and wired communications.

Communications interface 1960 may connect to an antenna assembly (not shown in FIG. 19) for transmission and/or reception of the RF signals. The antenna assembly may include one or more antennas to transmit and/or receive RF signals over the air. The antenna assembly may, for example, receive RF signals from communications interface 1960 and transmit the RF signals over the air, and receive RF signals over the air and provide the RF signals to communications interface 1960. In one implementation, for example, communications interface 1960 may communicate with a network (e.g., wireless network, Internet, Intranet, etc.).

As will be described in detail below, device 1900 may perform certain operations. Device 1900 may perform these operations in response to processor 1920 executing software instructions (e.g., a computer program(s)) contained in a computer-readable medium, such as memory 1930, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 1930 from another computer-readable medium or another device. The software instructions contained in memory 1930 may cause processor 1920 to perform processes described herein. Alternatively, hardwired circuitry may be used in place of or in combination with software instructions to implement processes described herein. Thus, implementations described herein are not limited to any specific combination of hardware circuitry and software.

As described in and for FIGS. 1 to 19, reference is made to the accompanying figures, which form a part hereof, and in which is shown by way of illustration specific embodiments in which the invention may be practiced. Whenever possible, the same reference numbers are used in the drawings and the description to refer to the same or like parts. Directional terminology, such as “top”, “bottom”, “front”, “back”, “leading”, “trailing” etc., is used with reference to the orientation of the Figure(s) being described. Since components of embodiments of the present invention can be positioned in a number of different orientations, directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. (canceled)

2. (canceled)

3. (canceled)

4. (canceled)

5. (canceled)

6. (canceled)

7. (canceled)

8. An apparatus, comprising:
a rotating pole;
a first arm with one end of the first arm attached to the rotating pole and the other end of the first arm attached to a top portion of a panel that is attached to a photovoltaic module;
a second arm with one end of the second arm attached to the rotating pole and the other end of the second arm attached to a bottom portion of the panel that is attached to the photovoltaic module;
wherein the first arm is at a first length and the second arm is at a second length,
wherein the first length does not change in size and the second length is at a length greater than the first length such that the photovoltaic module has a tilt angle,
wherein the first length, the second length, and the tilt angle are
r related to each other by:
$$second length = first lengt h + \frac{Diam e t e r}{tan ( tilt angle )}$$
wherein the diameter is the diameter of the apparatus.

9. The apparatus of claim 8, wherein the second arm has a linear actuator.

10. The apparatus of claim 9, wherein the linear actuator moves the photovoltaic module in a direction facing the sun.

11. The apparatus of claim 9, wherein the pole rotates based on wind speed.

12. The apparatus of claim 9, wherein the tilt angle is related to an azimuth angle.

13. A method, comprising:
receiving, by a hybrid solar and wind system, information about a location of a sun;
adjusting, by the hybrid solar and wind system, an arm length of an arm based on the information about the location of the sun;
adjusting, by the hybrid solar and wind system, a photovoltaic module based on the adjustment of the arm length;
not adjusting, by the hybrid solar and wind system, another arm length of another arm based on the information about the location of the sun; and
receiving, by the hybrid solar and wind system, wind power;
rotating, by the hybrid solar and wind system, a pole based on receiving the wind power,
wherein the arm and the other arm are connected to the pole and also connected to a panel attached to the photovoltaic module, and
wherein the photovoltaic module rotates based on the wind power rotating the pole.

14. The method of claim 13, wherein the photovoltaic module is at a tilt angle to the pole.

15. The method of claim 13, wherein the arm is at a greater length than the other arm.

16. The method of claim 15, wherein the arm has a linear actuator.

17. The method of claim 15, wherein the other arm does not have the linear actuator.

18. The method of claim 15, wherein the other arm has a linear actuator.
